(19) United States
(12) Patent Application Publication
(10) Pub. No.: US 2023/0407436 A1
(43) Pub. Date: Dec. 21, 2023

(54) CONCERTED MINERAL CARBONATION AND SELECTIVE LEACHING OF LATERITES

(71) Applicant: The University of British Columbia, Vancouver (CA)

(72) Inventors: David DREISINGER, Delta (CA); Fei WANG, Vancouver (CA)

(21) Appl. No.: 18/249,144

(22) PCT Filed: Oct. 14, 2021
(86) PCT No.: PCT/CA2021/051445

§ 371 Date: Apr. 14, 2023

Related U.S. Application Data
(60) Provisional application No. 63/091,611, filed on Oct. 14, 2020.

(51) Int. Cl. C22B 3/00; C22B 23/00; C22B 3/44; C22B 3/22; C01F 5/24; C01G 49/00

(52) U.S. Cl. CPC C22B 23/0461; C22B 23/005; C22B 3/44; C22B 3/22; C01F 5/24; C01G 49/00

(57) ABSTRACT

Processes are provided for treating mineralized silicates by selective leaching of Ni and Co values carried out in concert with sequestration of gaseous CO₂ as mineral carbonates. These processes may be applied to extract Ni and Co values from disparate laterite ores.

### FIELD

Processes are disclosed that combine CO₂ sequestration by mineral carbonation and selective hydrometallurgical recovery of metal values from silicate minerals.

### BACKGROUND

Nickel and cobalt are of value in an increasing range of applications, for example in NMC lithium ion batteries. The majority of the world's nickel reserves are found in silicate mineral deposits, particularly in the form of laterites, termed lateritic nickel ore deposits, and these deposits include significant amounts of cobalt in the form of Ni—Co laterite deposits (see Berger, V. I., Singer, D. A., Bliss, J. D., and Moring, B. C., 2011, Ni—Co laterite deposits of the world, database and grade and tonnage models: U.S. Geological Survey Open-File Report 2011-1058).

Challenges remain in the production of nickel and cobalt from laterites. Hydrometallurgical approaches, including high pressure acid leaching (HPAL), can suffer from complications that attend the treatment of different laterite layers (typically made up of saprolite-type ores as distinguished from limonite-type ores). There remains a need for processes capable of selective nickel and cobalt production from a variety of laterite materials.

Sequestration of carbon dioxide gas in the form of solid mineral carbonates has been suggested as an approach that may assist in ameliorating anthropogenic climate change. Approaches that combine carbon mineralization with the extraction of metal values from abundant ores would offer opportunities to extract industrially necessary materials while reducing the environmental impact of that extraction.

### SUMMARY

Processes are provided for extracting values from a mineralized silicate material, including mineralized silicate materials comprising a total amount of each of a mineralized nickel, a mineralized cobalt, a mineralized iron and a mineralized magnesium. The mineralized silicate material may include a non-hydrated nickel-containing olivine material, for example a material represented by the formula (Fe, Mg, Ni, Co)₂SiO₄).

The mineralized silicate material may alternatively be provided by calcining a hydrated mineral feedstock, such as a laterite material (e.g. a lateritic nickel ore), to provide the mineralized silicate material. The laterite material may for example comprise a saprolite-type ore and/or a limonite-type ore. Hydrated mineral feedstocks may alternatively include serpentine materials, for example of formula (Fe, Mg, Ni, Co)₃Si₂O₅(OH)₄), and/or montmorillonite materials, for example of formula (Na, Ca)(Fe, Mg, Ni, Co)₂(Si, Al)₄O₁₀ (OH)₂nH₂O). Calcining may for example be carried out at a calcining temperatures of 600° C.-800° C., in the presence of a calcining atmosphere, for example comprising a CO—CO₂ gas, a CO—N₂ gas or a CO—CO₂—N₂ gas. Where hydrated mineral feedstock include goethite and/or hematite and/or magnetite, the calcination may be carried out in a slightly reductive calcining atmosphere, for example containing CO or H₂, so as to convert at least some of the goethite and/or hematite and/or magnetite materials to wustite materials.

Processes are provided that involve heating mineralized silicate materials in an aqueous buffered extraction medium, for example a H₂CO₃₍ₐ₎/HCO₃⁻ buffered medium, in the presence of a carbon dioxide supply (gaseous, liquid or solid) and a selective Ni/Co ligand. In this way, carbonation reactions and selective leaching reactions are mutually reinforcing, or synergistic. Extraction conditions may accordingly be adapted to orchestrate concerted:
selective leaching of nickel and cobalt from the silicate material into the extraction medium in the form of complexes with a selective Ni/Co ligand, to form solubilized Ni complexes and solubilized Co complexes; and,
reaction of magnesium and/or iron and/or calcium in the silicate material with dissolved carbon dioxide provided by the carbon dioxide supply to form a solid carbonate product, for example comprising a solid magnesium carbonate and/or a solid iron carbonate and/or a solid calcium carbonate. In select embodiments, the solid magnesium carbonate may include magnesite and/or the solid iron carbonate may include siderite.

In a solid/liquid separation, the solid magnesium and iron carbonates may be separated from the solubilized Ni complexes and the solubilized Co complexes, forming a Ni/Co pregnant leach solution. Ni and Co values may be recovered from the Ni/Co pregnant leach solution to form a Ni/Co depleted barren solution, and recirculating the Ni/Co depleted barren solution to the aqueous buffered extraction medium.

Extraction conditions may be provided so that the Ni/Co ligand is provided in a molar ratio to the total amount of mineralized Ni in the mineralized silicate material that is, for example greater than 1:1. Extraction conditions may demonstrably be modulated so as to extract at least 50%, 60%, 70% 80% or 90% of the total amount of mineralized Ni and Co in the mineralized silicate material into the Ni/Co pregnant leach solution. Similarly, extraction conditions may demonstrably be modulated so that less than 20%, 15% or 10% of the total amount of the mineralized Fe and Mg in the mineralized silicate material is leached into the Ni/Co pregnant leach solution.

In selective embodiments, a moderately reductive calcining atmosphere may be used, which includes CO, for example in an amount of from 3˜15 (v/v) % in a CO—N₂ calcining gas or 10˜40 (v/v) % in a CO—CO₂ calcining gas mixtures.

The selective Ni/Co ligand may be a Ni and Co chelating agent. Alternative selective Ni/Co ligands may be used, where the relative stability of nickel- and cobalt-ligand complex ions is higher than the stability of ferrous- and magnesium-ligand complex ions and of the corresponding carbonates, as illustrated by the exemplified embodiments trisodium nitrilotriacetate (NTA) or ethylenediaminetetraacetic acid (EDTA). The molar ratio of the selective Ni/Co ligand to the total amount of mineralized Ni in the mineralized silicate material may for example be less than or equal to 50:1, 40:1, or 36:1, or 12:1.

The mineralized silicate material may be present in the aqueous H₂CO₃₍ₐ₎/HCO₃⁻ buffered extraction medium at a pulp density of 0.1-50 (wt) %, or 0.5-30 (wt) % or 0.5-5 (wt) %. The mineralized silicate material has a P₈₀=5-150 μm, or P₈₀=10-100 μm, or P₈₀=15-50 μm, or P₈₀=20-30 μm.

In select embodiments, the dissolved CO₂ from the carbon dioxide supply is reacted to form the solid carbonate product so that at least 50, 100, 150, 200 or 250 kg CO₂ are consumed per tonne of mineralized silicate material. In an alternative metric of efficiency, the mineral carbonation (MC) efficiency may be greater than 10%, 20%, 30%, 40%, 50%, 60% or 70%. where MC efficiency is the amount of CO₂ in the CO₂ gas supply that forms the carbonate product as a percentage of the theoretical maximum amount of CO₂ that the silicate material could react with to form carbonates of iron, magnesium, and calcium.

### BRIEF DESCRIPTION OF THE DRAWINGS

FIG. 1 is a schematic illustration of a hydrometallurgical process for selectively recovering nickel and cobalt from laterites and concurrently sequestering greenhouse CO2 gas as mineral carbonates

FIG. 2 includes two graphs illustrating highly selective nickel and cobalt leaching from a calcined saprolite laterite with concurrent mineral carbonation.

FIG. 3 includes two graphs illustrating the effect of CO₂ pressure and CO pressure on selective nickel and cobalt leaching from a calcined saprolite laterite with concurrent mineral carbonation.

FIG. 4 includes two graphs illustrating highly selective nickel leaching from olivine and concurrent mineral carbonation.

FIG. 5 includes two graphs illustrating the effect of calcination atmosphere on selective nickel and cobalt leaching from saprolite laterite and concurrent mineral carbonation.

FIG. 6 is a graph illustrating the effect of calcination temperature on selective nickel leaching from saprolite laterite and concurrent mineral carbonation.

FIG. 7 includes two graphs illustrating the effect of calcination atmosphere on nickel leaching from limonite laterite and concurrent mineral carbonation.

FIG. 8 includes five micrographs and a graph, illustrating the effect of increasing ligand dosage on addressing passivation layer of high iron content for nickel leaching and mineral carbonation from a calcined saprolite laterite.

FIG. 9 is a graph illustrating nickel sulfide precipitation from leached solution in presence of NTA.

### DETAILED DESCRIPTION

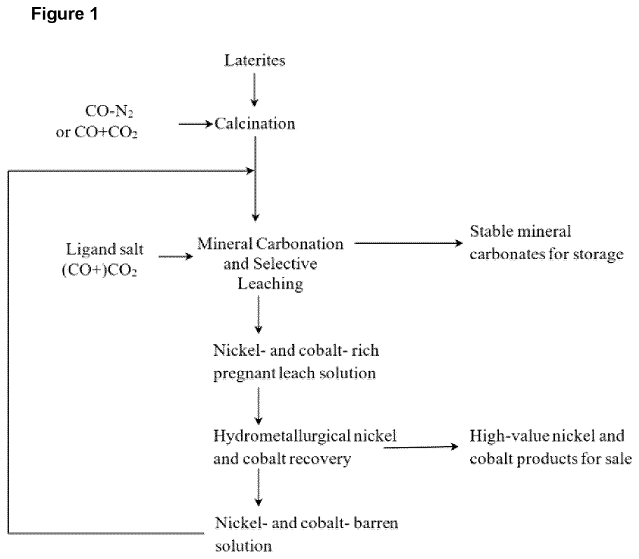

As illustrated schematically in FIG. 1, processes are provided for selectively recovering nickel and cobalt from mineralized silicate materials, and from hydrated silicate materials, such as laterites, with concurrent sequestration of CO₂ gas as mineral carbonates. These methods may be adapted for processing of nickel-rich silicate minerals, such as laterites, particularly lateritic nickel ore deposits and Ni—Co laterite deposits, including from saprolite-type ores and from limonite-type ores.

In select embodiments, processes are provided for treating non-hydrated nickel-containing olivine materials (represented herein as (Fe, Mg, Ni, Co)₂SiO₄). After size-reduction, nickel and cobalt can be directly selectively leached from olivine materials utilizing direct aqueous mineral carbonation with the addition of a selective Ni/Co ligand at elevated temperatures in the presence of a CO₂ supply. Mineralized magnesium and iron from the olivine materials reacts with dissolved CO₂ in a H₂CO₃₍ₐ₎/HCO₃⁻ buffered extraction medium to form solid magnesium carbonate and solid iron carbonate, for example in the form of stable magnesite (MgCO₃) and siderite (FeCO₃). At the same time, the mineralized nickel and cobalt are selectively leached from the olivine materials into aqueous solution as complex ions with the selective Ni/Co ligand. After solid/liquid separation, to separate solid carbonates from aqueous complex ions and thereby form a Ni/Co pregnant leach solution, nickel and cobalt values can be recovered as high-valued nickel and cobalt products, such as nickel cathodes, nickel sulfides or cobalt sulfides. The nickel- and cobalt-depleted barren solution can be recycled for direct aqueous mineral carbonation.

Hydrated nickel-containing silicate minerals may also be treated, including serpentine materials and montmorillonite materials (represented herein respectively as (Fe, Mg, Ni, Co)₃Si₂O₅(OH)₄) and (Na, Ca)(Fe, Mg, Ni, Co)₂(Si, Al)₄O₁₀ (OH)₂nH₂O), for example in saprolite laterites). The hydrated silicate minerals are first calcined, for example under nitrogen, CO and/or CO₂ gas atmosphere, to convert the hydrated silicates to olivine materials. Where associated iron oxide minerals are present, such as goethite, hematite or magnetite, a slightly reductive calcination atmosphere comprising CO may be used to convert these materials to wustite materials. Suitable concentrations of CO gas in gas mixtures may be from 3˜15 (v/v) % for CO—N₂ gas mixtures or 10˜40 (v/v) % for CO—CO₂ gas mixtures. The calcined silicate minerals can then be subjected to aqueous mineral carbonation and concurrent nickel and cobalt leaching with addition of Ni/Co selective ligands, e.g. EDTA or trisodium nitrilotriacetate (NTA salt). In the carbonation reactions, bivalent metals such as magnesium, iron and calcium can effectively sequester gaseous CO₂ by conversion to stable mineral carbonates. In Ni and Co leaching reactions, concurrently with aqueous mineral carbonation, extracted nickel and cobalt are stabilized in association with the Ni/Co selective ligands as nickel and cobalt complex ions in aqueous solution. The Ni/Co pregnant leach solution may then be subject to further steps of hydrometallurgical recovery of Ni and Co values.

Nickel- and cobalt-containing iron oxide minerals may also be treated, for example goethite materials derived from limonite saprolites. In these embodiments, calcination, as described above, under gas mixtures of CO—CO₂ or CO—N₂ may be used to convert iron oxide to nickel-containing wustite. Calcined iron oxide minerals may then be directed to aqueous mineral carbonation and concurrent nickel and cobalt leaching. As such, nickel and cobalt are leached into aqueous solution as nickel and cobalt complex ions, while bivalent iron is reacted so as to sequester CO₂ to form stable siderite materials.

Temperatures for calcination processes disclosed herein may for example be in the range of 600° C.-800° C. Calcination atmospheres, for example of CO—CO₂ or CO—N₂ gas mixtures, may be adjusted for desired outcomes. For example, the CO concentration in CO—N₂ gas mixtures for calcination of nickel-containing silicate minerals associated with iron oxide may be about 3 (v/v) %-15 (v/v) %. In some embodiments, a lower CO concentration may not effectively reduce nickel-containing iron oxide to wustite for mineral carbonation, while a higher CO concentration may result in formation of ferronickel which may hinder mineral carbonation and nickel leaching.

There is a degree of cooperation or synergy between the leaching and carbonation reactions disclosed herein. Direct aqueous mineral carbonation facilitates concurrent nickel and cobalt leaching by releasing mineralized bivalent nickel and cobalt ions from silicate and oxide crystal structures. In this way, effective nickel and cobalt leaching is enhanced by mineral carbonation reactions, and in turn the complexation leaching reactions enhance mineral carbonation reactions.

As disclosed herein, Ni/Co selective ligands are used to facilitate nickel and cobalt leaching with concurrent mineral carbonation. In the leaching medium, the stability of nickel- and cobalt-ligand complex ions is beneficially higher than the stability of ferrous- and magnesium-ligand complex ions and of the corresponding carbonates. Suitable Ni/Co selective ligands may include, but are not limited to, NTA or EDTA (for example in the form of added trisodium nitrilotriacetate Na₃NTA). The slightly higher stability of nickel- and cobalt-ligand complex ions, e.g. NTA complex ions, than the corresponding carbonates is beneficial to the selectivity of leaching nickel and cobalt over iron and magnesium, and thereby facilitates the subsequent recovery of nickel and cobalt from aqueous solution.

The integration of mineral carbonation and nickel and cobalt leaching in an integrated single one step is facilitated by the relative stability of complex ions of bivalent metals formed with Ni/Co selective ligands, e.g. NTA and EDTA, in aqueous solution compared to solid mineral carbonates as shown in Table 1.

TABLE 1
Stability of bivalent metal carbonates
and complex ions with NTA and EDTA

| Bivalent | Stability of | Stability of complex | Stability of complex |
|---|---|---|---|
| metal | carbonates, | ions with NTA, | ions with EDTA, |
| ions | logK_{stability} | logK_{stability} | logK_{stability} |
| Mg²⁺ | 5.07 | 5.46 | 8.69 |
| Ca²⁺ | 8.30 | 6.41 | 10.70 |
| Fe²⁺ | 8.28 | 8.84 | 14.33 |
| Co²⁺ | 9.32 | 11.0 | 16.31 |
| | | 12.0 ([CoNTA₂]⁴⁻) | |
| Ni²⁺ | 11.01 | 12.8 | 18.62 |
| | | 17.0 ([NiNTA₂]⁴⁻) | |

Selective nickel and cobalt leaching over iron and magnesium from olivine materials is attributable to the formation of more stable complex ions of nickel and cobalt compared to complex ions of iron and magnesium, as shown in Table 1.

Suitable dosages of Ni/Co selective ligands, e.g. EDTA or NTA, facilitates selective nickel and cobalt leaching and concurrent mineral carbonation processes. In some embodiments, a suitable ligand dosage range may for example be greater than 1:1, or from 1˜36, in molar ratio of Ni/Co selective ligand to total mineralized nickel, i.e. the NTA/Ni or EDTA/Ni ratio. In some embodiments, a lower ligand dosage may result in relatively low nickel and cobalt leaching efficiencies. In contrast, higher ligand dosages may result in decreasing leaching selectivity for nickel and cobalt over iron and magnesium. In some embodiments, increasing the dosage of Ni/Co selective ligands can address difficulties associated with mineral carbonation of olivine materials caused by a relatively high iron content in the olivine materials.

The CO₂-containing gas supply to the carbonation and leaching reactions may be provided so as to sustain a bicarbonate buffered leach medium, in effect enhancing the supply of carbonate and bicarbonate ions from CO₂ gas for purposes of mineral carbonate precipitation. The added CO₂ gas may also be used to facilitate diffusion and decomposition of aqueous silica to amorphous silica or quartz.

In select embodiments, mineral carbonation may be accelerated by providing slightly reductive reagent, e.g. CO or H₂ gas. The slightly reductive atmosphere comprising the reductive reagent can be used so as to ameliorate competitive oxidation of bivalent iron and thus enhance mineral carbonation processes.

In select embodiments, the H₂CO₃₍ₐ₎/HCO₃⁻ buffered extraction medium forms a slurry during mineral carbonation and concurrent nickel and cobalt leaching reactions, with a pH close to neutral (pH 7˜8) at the outset. After solid/liquid separation, the pH of solution is slightly basic (e.g. pH at around 8.3).

Following mineral carbonation and concurrent nickel and cobalt leaching reactions, solid carbonate residues are formed that are easier to separate from the extraction medium slurry than would be the raw silicate minerals, especially amorphous laterites. This may for example be achieved by carrying out the mineral carbonation reactions so as to convert clay minerals predominantly to crystalline mineral carbonates and quartz.

Pregnant nickel- and cobalt-rich leach solutions can be directed to hydrometallurgical recovery processes, for example to produce high-value nickel and cobalt products. These hydrometallurgical recovery processed may for example include solvent extraction and electrowinning to produce cathode nickel, or sulfide precipitation as nickel sulfide and cobalt sulfide.

Nickel- and cobalt-depleted barren solutions can be recycled to the buffered extraction medium for the leaching and mineral carbonation reactions. In this way, Ni/Co selective ligands, e.g. EDTA or NTA salts, can be recycled together with the barren solution to selectively leach nickel and cobalt and to accelerate mineral carbonation.

In select embodiments, the following reactions may take place in calcination processes disclosed herein:

$$2 {( Fe , Mg , Ni , Co )}_{3} {Si}_{2} {{O}_{5} ( OH )}_{4} ( serpentine ) {\to }^{{CO}^{600 - 800 ° C .}} 3 {( Fe , Mg , Ni , Co )}_{2} {SiO}_{4} ( olivine ) + {SiO}_{2} ( quartz ) + 4 {H}_{2} O ( g )$$

$$( Na , Ca ) {( Fe , Mg , Ni , Co )}_{2} {( Si , Al )}_{4} {{O}_{10} ( OH )}_{2} \cdot {n H}_{2} O ( Montmorillonite ) {\to }^{{CO}^{600 - 800 ° C .}} ( Na , Ca ) {( Fe , Mg , Ni , Co )}_{2} {SiO}_{5} ( olivine ) + 3 {SiO}_{2} ( quartz ) + ( n + 1 ) {H}_{2} O ( g )$$

$$2 {( Fe , Mg , Ni , Co )}_{3} {Si}_{4} {{O}_{10} ( OH )}_{2} ( talc ) {\to }^{{CO}^{600 - 800 ° C .}} 3 {( Fe , Mg , Ni , Co )}_{2} {SiO}_{4} ( olivine ) + 5 {SiO}_{2} ( quartz ) + 2 {H}_{2} O ( g )$$

$$2 ( Fe , Ni , Co ) OOH ( geothite ) {\to }^{\sim 300 ° C .} {( Fe , Ni , Co )}_{2} {O}_{3} ( hematite ) + {H}_{2} O ( g )$$

$${( Fe , Ni , Co )}_{2} {O}_{3} ( hematite ) + CO ( g ) \to 2 ( Fe , Ni , Co ) O ( wustite ) + {CO}_{2} ( g )$$

In select embodiments, the following reactions may take place in mineral carbonation and leaching reactions disclosed herein:
(Fe, Mg, Ni, Co)₂SiO₄(olivine)+4H⁺→Ni²⁺+Co²⁺+Fe²⁺+Mg²⁺+H₄SiO₄(a)
(Fe, Ni, Co)O(wustite)+2H⁺→Ni²⁺+Co²⁺+Fe²⁺+H₂O(l)
Ni²⁺+HNTA²⁻→Ni(NTA)⁻+H⁺
Ni²⁺+2HNTA²⁻→[Ni(NTA)₂]⁴⁻+2H⁺
Co²⁺+HNTA²⁻→Co(NTA)⁻+H⁺
Co²⁺+2HNTA²⁻→[Co(NTA)₂]⁴⁻+2H⁺
Fe²⁺+CO₃²⁻→FeCO₃
Mg²⁺+CO₃²⁻→MgCO₃
CO₂+H₂O(l)→H⁺+HCO₃⁻
HCO₃⁻→H₊+CO₃²⁻
NTA³⁻+CO₂+H₂O(a)→HNTA²⁻+HCO₃⁻
4HNTA²⁻+(Ni, Co)₂SiO₄(Ni, Co in olivine)→2[(Ni, Co)(NTA)₂]⁴⁻+H₄SiO₄(a)
4HNTA²⁻+(Mg, Fe)₂SiO₄(Mg, Fe in olivine)→2[(Mg, Fe)(NTA)₂]₄₋+H₄SiO₄(a)
2HNTA²⁻+(Mg, Fe)₂SiO₄(Mg, Fe in olivine)+2CO₂+2H₂O(l)→2[(Mg, Fe)NTA]⁻+2HCO₃⁻+H₄SiO₄(a)
(Fe, Ni, Co)O(wustite)+2HNTA²⁻→[(Fe, Ni, Co)(NTA)₂]⁴⁻+H₂O(l)
H₄SiO₄(a)→SiO₂+H₂O(l)

Selective nickel and cobalt leaching during mineral carbonation is facilitated by the following reactions, with generally increasing reaction times mediated by use of suitable dosages of Ni/Co selective ligands.
[Mg(NTA)₂]⁴⁻+Fe²⁺→[Fe(NTA)₂]⁴⁻+Mg²⁺
[Fe(NTA)₂]⁴⁻+Ni²⁺→[Ni(NTA)₂]⁴⁻+Fe²⁺
[Fe(NTA)₂]⁴⁻+Co²⁺→[Co(NTA)₂]⁴⁻+Fe²⁺
[MgNTA]⁻+Fe²⁺→[FeNTA]⁻+Mg²⁺
[FeNTA]⁻+Ni²⁺→[NiNTA]⁻+Fe²⁺
[FeNTA]⁻+Co²⁺→[CoNTA]⁻+Fe²⁺

Selective nickel and cobalt leaching during mineral carbonation is also facilitated by the relative stability of complex ions in the H₂CO₃₍ₐ₎/HCO₃⁻ buffered extraction medium, as mediated by a suitable dosage of ligand, as indicated in the following reactions.
[MgNTA]⁻+HCO₃⁻→MgCO₃↓+[HNTA]²⁻
[FeNTA]⁻+HCO₃⁻→FeCO₃↓+[HNTA]²⁻
CO₂+H₂O(l)→H⁺+HCO₃⁻

### EXAMPLES

### Example 1: Selective Nickel and Cobalt Leaching from a Calcined Saprolite Laterite and Concurrent Mineral Carbonation

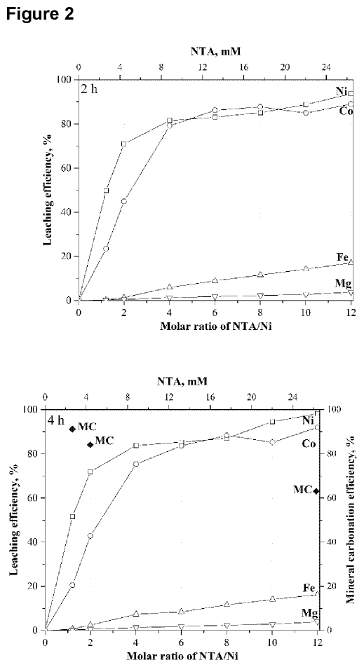

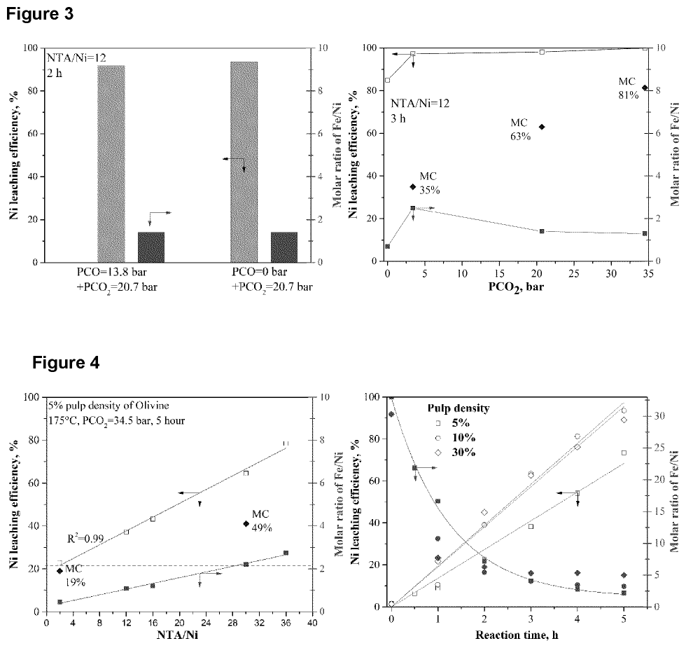

An exemplary embodiment of highly selective nickel and cobalt leaching from a calcined saprolite laterite and concurrent mineral carbonation is reflected in the data shown in FIG. 2 and FIG. 3. The extraction conditions provided were: 175° C., PCO₂=20.7 bar, PCO=13.8 bar, 0.5% pulp density, P₈₀=27 um, 1.5 m NaHCO₃, molar ratio of NTA/total nickel=0˜12 (i.e. 0˜26 mM) and the feed laterite is from calcination at 700° C., 300 mL/min flow of gas mixture containing 7% CO+93% N₂ for 1 hour. With increasing NTA dosage to NTA/Ni molar ratio=12, nickel and cobalt dramatically increased to 93% of Ni and 89% of Co at 2 hours and to 98% of Ni and 92% of Co at 4 hours, respectively. In contrast, Fe and Mg leaching efficiency is less than 16% and 4% even at NTA/Ni molar ratio=12. At 4 hours, although there is a slight decrease in mineral carbonation (MC) with increasing NTA dosage, the mineral carbonation (MC) efficiency can still achieve 64% (i.e. 258 kg CO₂/t raw ore can be sequestered) at NTA/Ni molar ratio=12. FIG. 3 shows the robust suitability of CO₂ and CO partial pressure for selective leaching and mineral carbonation. Usage of CO during mineral carbonation and leaching has no obvious effect on leaching and carbonation. Selective nickel (and cobalt) leaching and mineral carbonation can maintain robust at various CO₂ pressure. At low CO₂ pressure less than 1 bar, around 85% of nickel can be still leached while less than 11% of iron is leached (i.e., molar ratio of leached Fe/Ni=0.7). With increasing CO₂ pressure to 34 bar, the MC efficiency gradually increased to 81% (i.e., 330 kg CO₂/t raw ore can be sequestered) together with more than 98% nickel leaching efficiency whereas the molar ratio of leached Fe/Ni maintained at less than 1.4.

Mineral carbonation (MC) efficiency, as reported herein, is the amount of sequestered CO₂ as a percentage of the theoretical maximum amount of sequestered CO₂ of the raw material, where the theoretical maximum amount of sequestered CO₂ of the raw material, also called mineral carbonation capacity, is based on the total content of iron, magnesium, and calcium in the raw material, on the assumption that each mole of the metals can sequester a mole CO₂ gas.

### Example 2 Selective Nickel Leaching from Olivine with Concurrent Mineral Carbonation

An exemplary embodiment of highly selective nickel leaching from olivine materials with concurrent mineral carbonation is reflected in the data shown in FIG. 4. The exemplified conditions are at 175° C., PCO₂=34 bar, 5˜30 (wt) % pulp density, 25˜38 μm of pure olivine, 1.5 m NaHCO₃, molar ratio of NTA/total nickel=2˜36, 5 hours reaction. At 5% pulp density, the nickel leaching efficiency is proportional to the dosage of NTA, from 22% at NTA/Ni=2 to 65% at NTA/Ni=30 and 78% at NTA/Ni=36, respectively. Without usage of NTA, the MC efficiency is around 20%. With increasing NTA dosage, MC increases to 49% (i.e. 265 kg CO₂ per ton olivine can be sequestered) at molar ratio of NTA/Ni=30. Although the molar ratio of leached Fe/Ni increases with increasing NTA dosage, the Fe/Ni molar ratio is less than 2.2 at NTA/Ni=30 and 2.7 at NTA/Ni=36. This selective nickel leaching and mineral carbonation process is demonstrably amenable to relatively high pulp densities of olivine materials, e.g. 30 (wt) %. At 30 (wt) % pulp density, the nickel leaching efficiency is even higher than at 5% pulp density, and reaches about 90% in conjunction with increased NTA concentration in aqueous solution.

### Example 3: Effects of Calcination Atmosphere on Selective Nickel and Cobalt Leaching from Calcined Laterites and Mineral Carbonation

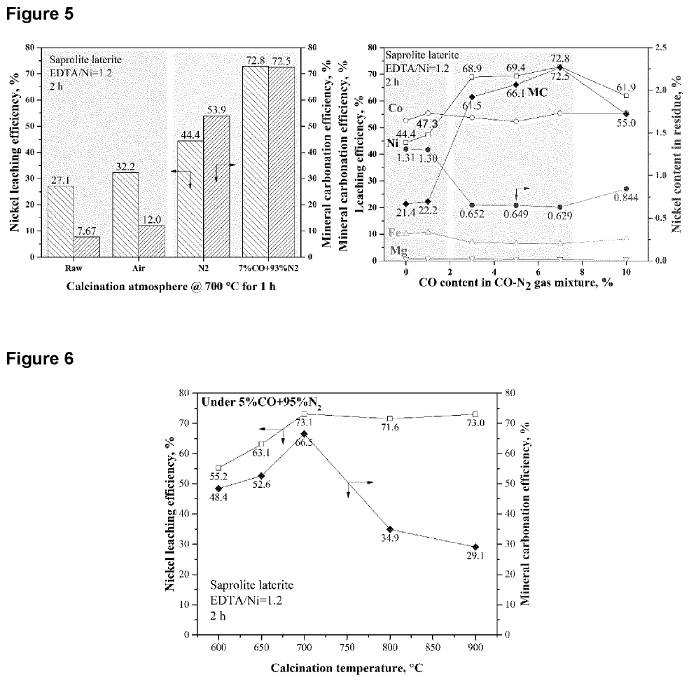

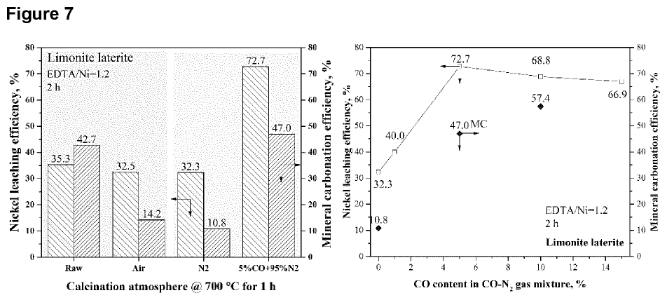

This example illustrates the effects of calcination atmosphere on selective nickel and cobalt leaching from calcined laterites and mineral carbonation, as shown in FIGS. 5-7. As illustrated, disodium EDTA, at EDTA/Ni=1.2, works as an effective Ni/Co selective ligand to selectively leach nickel and cobalt from calcined laterites. FIGS. 5-6 illustrate this in the treatment of a saprolite laterite material. Calcination conditions were 700° C., 300 mL/min flow of gas mixture for 1 hour, followed by selective leaching and carbonation at 175° C., PCO2=34 bar, 0.5 (wt) % pulp density, 1.5 m NaHCO3, 0.5 m sodium sulfite working as reductive reagent, molar ratio of EDTA/total nickel=1.2, 2 hours reaction. FIG. 5 illustrates that the slightly reductive atmosphere of calcination is beneficial for the effective leaching of nickel and cobalt with concurrent mineral carbonation, and that a suitable CO concentration in the CO—N2 gas mixture in this embodiment is 3˜7 (v/v) %. At 7 (v/v) % CO+93 (v/v) % N₂ calcination, nickel and cobalt leaching efficiency reached 72% and 55% respectively in combination with 72% mineral carbonation efficiency (i.e. 294 kg CO₂ per ton raw laterite sequestered) while less than 10% of iron and 0.6% of magnesium were leached. The slightly reductive atmosphere ameliorates oxidation of Fe(II) during conversion of hydrated silicate minerals to olivine materials and converts iron oxide minerals to wustite materials. If the CO concentration is relatively high during calcination, e.g. 10% CO+90% N2, ferronickel may be produced thereby reduceing the effectiveness of nickel leaching and mineral carbonation. With the exemplified supply of CO—N₂ gas, the optimal range of calcination temperature for the exemplified saprolite laterite is 600˜800° C. as shown in FIG. 6. FIG. 7 illustrates the effectiveness of the disclosed processes on a limonite laterite, with about 70% of the total mineralized nickel being leached, with concurrent 57% mineral carbonation efficiency. In this embodiment, a suitable CO concentration in the CO—N₂ gas mixture for calcination of the limonite laterite was 3˜10 (v/v) %.

### Example 4 Ni/Co Selective Ligand Effects

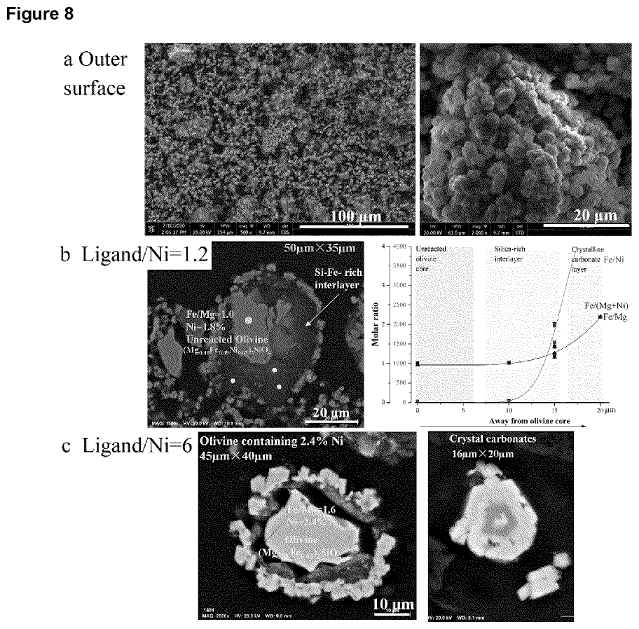

This example illustrates the effects of Ni/Co selective ligands on enhancing selective nickel and cobalt extraction from a high iron content laterite and concurrent mineral carbonation, as illustrated by the data shown in FIG. 8. The outer surface (FIG. 8a) shows the effects of mineral carbonation processes, with massive mineral carbonates. At very low dosage of ligands, e.g. EDTA/Ni=1.2 where the nickel leaching efficiency is 71%, a passivation layer forms between unreacted olivine containing Fe/Mg=1.0 and crystalline carbonates. As shown in FIG. 8b, the passivation layer is Si—Fe— rich layer; nickel from the olivine material is the priority for leaching, followed by magnesium; ferrous components from the olivine materials are the lowest priority for leaching. By increasing the dosage of Ni/Co selective ligand, e.g. NTA/Ni=6, the passivation layer is removed and the nickel leaching efficiency reaches 85%. Increasing ligand dosage can accordingly be beneficial by removing passivation layers that result from high iron content in olivine materials.

### Example 5 Nickel Sulfide Precipitation from Leached Solution

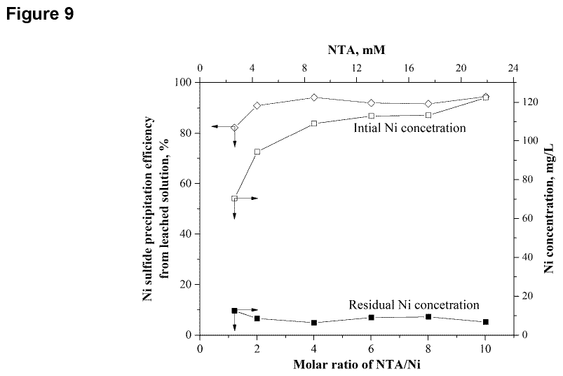

This Example illustrates effective nickel sulfide precipitation from a pregnant leach solution to recover nickel in presence of ligand, as illustrated in FIG. 9. The exemplified pregnant leach solution is from selective nickel and cobalt leaching and mineral carbonation at 175° C., 1.5 M sodium bicarbonate and NTA/Ni molar ratio 1.2˜10. The nickel sulfide precipitation is at 120° C., gas mixture of 5% H₂S+95% CO₂ (PH₂S+CO₂=30 bar), 1 h reaction, where pH and Eh maintain at around 8.0 and −0.46V respectively. More than 90% of aqueous nickel in presence of NTA complex ions precipitates as nickel sulfide. Since the feed solutions also contain aqueous iron-NTA complex ions with Fe/Ni molar ratio less than 1.0, the high-value product is nickel-iron sulfide as pentlandite.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Terms such as “exemplary” or “exemplified” are used herein to mean “serving as an example, instance, or illustration.” Any implementation described herein as “exemplary” or “exemplified” is accordingly not to be construed as necessarily preferred or advantageous over other implementations, all such implementations being independent embodiments. Unless otherwise stated, numeric ranges are inclusive of the numbers defining the range, and numbers are necessarily approximations to the given decimal. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification, and all documents cited in such documents and publications, are hereby incorporated herein by reference as if each individual publication were specifically and individually indicated to be incorporated by reference herein and as though fully set forth herein. The invention includes all embodiments and variations substantially as hereinbefore described and with reference to the examples and drawings.

1. A process for extracting values from a mineralized silicate material, wherein the mineralized silicate material comprises a total amount of each of a mineralized nickel, a mineralized cobalt, a mineralized iron and a mineralized magnesium, wherein the process comprises:
a) heating the mineralized silicate material in an aqueous H₂CO₃₍ₐ₎/HCO₃⁻ buffered extraction medium in the presence of a gaseous carbon dioxide supply and a selective Ni/Co ligand;
b) providing extraction conditions to:
i) selectively leach nickel and cobalt from the silicate material into the extraction medium in the form of complexes with the selective Ni/Co ligand, to form solubilized Ni complexes and solubilized Co complexes; and,
ii) react magnesium and iron in the silicate material with dissolved carbon dioxide provided by the carbon dioxide supply to form a solid carbonate product comprising a solid magnesium carbonate and a solid iron carbonate; and,
c) in a solid liquid separation, separating the solid magnesium carbonate and the solid iron carbonate from the solubilized Ni complexes and the solubilized Co complexes, to form a Ni/Co pregnant leach solution;
wherein providing extraction conditions comprises: providing the Ni/Co ligand in a molar ratio to the total amount of mineralized Ni in the mineralized silicate material of greater than 1:1, so as to extract at least 50%, 60%, 70% 80% or 90% of the total amount of mineralized Ni and Co in the mineralized silicate material into the Ni/Co pregnant leach solution, and so that less than 20%, 15% or 10% of the total amount of the mineralized Fe and Mg in the mineralized silicate material is leached into the Ni/Co pregnant leach solution.

2. The process of claim 1, wherein the mineralized silicate material comprises a non-hydrated nickel-containing olivine material.

3. The process of claim 1, further comprising calcining a hydrated mineral feedstock to provide the mineralized silicate material.

4. The process of claim 3, wherein the hydrated mineral feedstock is a laterite material, optionally a lateritic nickel ore.

5. The process of claim 4, wherein the laterite material comprises a saprolite-type ore and/or a limonite-type ore.

6. The process of claim 3, wherein the hydrated mineral feedstock comprises a serpentine material of formula (Fe, Mg, Ni, Co)₃Si₂O₅(OH)₄) and/or a montmorillonite material of formula (Na, Ca)(Fe, Mg, Ni, Co)₂(Si, Al)₄O₁₀ (OH)₂nH₂O).

7. The process of claim 3, wherein calcining is carried out at a calcining temperature of 600° C.-800° C.

8. The process of claim 3, wherein calcining is in the presence of a calcining atmosphere comprising a CO—CO₂ gas, a CO—N₂ gas or a CO—CO₂—N₂ gas.

9. The process of claim 3, wherein the hydrated mineral feedstock comprises goethite and/or hematite and/or magnetite, and calcination is carried in a reductive calcining atmosphere so as to convert at least some of the goethite and/or hematite and/or magnetite materials to wustite materials.

10. The process of claim 9, wherein the reductive calcining atmosphere comprises CO in an amount of from 3˜15 (v/v) % in a CO—N₂ calcining gas or 10˜40 (v/v) % in a CO—CO₂ calcining gas mixtures.

11. The process of claim 1, wherein the selective Ni/Co ligand is a Ni and Co chelating agent.

12. The process of claim 1, wherein the selective Ni/Co ligand is trisodium nitrilotriacetate (NTA) or ethylenediaminetetraacetic acid (EDTA).

13. The process of claim 1, wherein the molar ratio of the selective Ni/Co ligand to the total amount of mineralized Ni in the mineralized silicate material is less than or equal to 50:1, or 40:1, 36:1 or 12:1.

14. The process of claim 1, wherein the solid magnesium carbonate comprises magnesite and/or the solid iron carbonate comprises siderite.

15. The process of claim 1, wherein the mineralized silicate material is present in the aqueous H₂CO₃₍ₐ₎/HCO₃⁻ buffered extraction medium at a pulp density of 0.1-50 (wt) %, or 0.5-30 (wt) % or 0.5-5 (wt) %.

16. The process of claim 1, wherein the mineralized silicate material has a P₈₀=5-150 μm, or P₈₀=10-100 μm, or P₈₀=15-50 μm, or P₈₀=20-30 μm

17. The process of claim 1, wherein the dissolved CO₂ from the carbon dioxide supply is reacted to form the solid carbonate product so that at least 50, 100, 150, 200 or 250 kg CO₂ are consumed per tonne of mineralized silicate material.

18. The process of claim 1, wherein the mineral carbonation (MC) efficiency is greater than 10%, 20%, 30%, 40%, 50%, 60% or 70%. wherein MC efficiency is the amount of CO₂ in the CO₂ gas supply that forms the carbonate product as a percentage of the theoretical maximum amount of CO₂ that the silicate material could react with to form carbonates of iron, magnesium, and calcium.

19. The process of claim 1, further comprising recovering Ni and Co values from the Ni/Co pregnant leach solution to form a Ni/Co depleted barren solution, and recirculating the Ni/Co depleted barren solution to the aqueous buffered extraction medium.
